(19) United States
(12) Patent Application Publication
(10) Pub. No.: US 2017/0049294 A1
(43) Pub. Date: Feb. 23, 2017

(54) WASH RACK FOR A DISHWASHER APPLIANCE

(71) Applicant: GENERAL ELECTRIC COMPANY, Schenectady, NY (US)

(72) Inventors: Joel Charles Boyer, Louisville, KY (US); Matthew David Mersch, Louisville, KY (US)

(21) Appl. No.: 14/832,158

(22) Filed: Aug. 21, 2015

(51) Int. Cl. A47L 15/16; B29C 67/00; A47L 15/50

(52) U.S. Cl. CPC A47L 15/16; A47L 15/50; B29C 67/0062; B29K 2027/06

(57) ABSTRACT

A dishwasher appliance includes a wash rack positioned within a wash chamber of a tub above a spray body. The wash rack includes a plurality of integrally formed elongated members that form a bottom wall and a pair of side walls. The integrally formed elongated members of the bottom wall form a pair of container support portions and a well portion, and the well portion of the bottom wall is positioned below the container support portions of the pair of container support portions. A related method for forming a wash rack for a dishwasher appliance is also provided.

### FIELD OF THE INVENTION

The present subject matter relates generally to wash racks for dishwasher appliances and methods for forming the same.

### BACKGROUND OF THE INVENTION

Dishwasher appliances generally include at least one dish rack for holding dishes, such as plates, bowls, utensils, glassware, pots, pans, and the like. Certain dish racks are constructed of a plurality of interconnected wires that form a basket. Tines are mounted within the basket for supporting the various dishes. The wires and tines are commonly made of metal, such as steel, covered with a protective coating, such as nylon or polyvinyl chloride (PVC). The protective coating provides a physical barrier over the wires and tines to protect the metal from exposure to water and fluid additives, such as detergents and rinse aids, within the dishwasher. As a result, the protective coating assists with preventing corrosion of the dish rack.

Constructing dish racks with metal wires and tines has drawbacks. For example, the protective coating does not always provide a sufficient barrier, and the metal wires and tines of the dish rack can rust in the harsh dishwasher environment. The protective coating can be compromised in a variety of ways, including aging of the protective material or physical damage, such as scratching, which can occur during loading of the dishwasher, especially when knives and other sharp items are loaded into the dishwasher. As another example, deficiencies in the coating process can lead to non-uniform, defective coatings that are susceptible to corrosion. Once corrosion initiates, the destructive process tends to propagate along the wires.

Constructing dish racks with metal wires and tines can also limit the size and shape of the basket. In particular, lateral metal wires are generally bent into a desired shaped, and straight transverse wires are then welded to the bent lateral metal wires to form the wash basket. Thus, a cross-section of the basket is generally constant from front to back, and evenly applying wash fluid to articles with the basket can be difficult due to such shaping.

Accordingly, a wash rack for a dishwasher appliance with features for limiting corrosion of the wash rack would be useful. In addition, a wash rack with features for assisting with supporting articles within the dish rack such that the articles are directed towards a spray body of the dishwasher appliance would be useful.

### BRIEF DESCRIPTION OF THE INVENTION

The present subject matter provides a dishwasher appliance with a wash rack positioned within a wash chamber of a tub above a spray body. The wash rack includes a plurality of integrally formed elongated members that form a bottom wall and a pair of side walls. The integrally formed elongated members of the bottom wall form a pair of container support portions and a well portion, and the well portion of the bottom wall is positioned below the container support portions of the pair of container support portions. A related method for forming a wash rack for a dishwasher appliance is also provided. Additional aspects and advantages of the invention will be set forth in part in the following description, or may be apparent from the description, or may be learned through practice of the invention.

In a first exemplary embodiment, a dishwasher appliance defining a vertical direction, a lateral direction and a transverse direction that are mutually perpendicular is provided. The dishwasher includes a tub that defines a wash chamber. A spray body is positioned within the wash chamber of the tub. A wash rack is positioned within the wash chamber of the tub above the spray body along the vertical direction. The wash rack includes a plurality of integrally formed elongated members. The integrally formed elongated members of the wash rack form a bottom wall, a pair of first side walls and a pair of second side walls. The side walls of the pair of first side walls spaced apart from each other along the lateral direction and extending upwardly from the bottom wall of the wash rack along the vertical direction. The side walls of the pair of second side walls spaced apart from each other along the transverse direction and extending upwardly from the bottom wall of the wash rack along the vertical direction. The integrally formed elongated members of the bottom wall form a pair of container support portions and a well portion. Each container support portion of the pair of container support portions positioned adjacent a respective one of the pair of first side walls. The well portion of the bottom wall positioned between the container support portions of the pair of container support portions along the lateral direction. The well portion of the bottom wall also positioned below the container support portions of the pair of container support portions along the vertical direction.

In a second exemplary embodiment, a method for forming a unitary wash rack for a dishwasher appliance is provided. The method includes establishing three-dimensional information of the unitary wash rack and converting the three-dimensional information of the unitary wash rack from the step of establishing into a plurality of slices. Each slice of the plurality of slices defining a respective cross-sectional layer of the unitary wash rack. The method also includes successively forming each cross-sectional layer of the unitary wash rack with an additive process. After the step of successively forming, (1) the unitary wash rack includes a plurality of integrally formed elongated members forming a bottom wall and a pair of side walls; (2) the side walls of the pair of side walls are spaced apart from each other and extend upwardly from the bottom wall; (3) the integrally formed elongated members of the bottom wall form a pair of container support portions and a well portion; (4) each container support portion of the pair of container support portions is positioned adjacent a respective one of the pair of side walls; (5) the well portion of the bottom wall is positioned between the container support portions of the pair of container support portions; and (6) the well portion of the bottom wall is also positioned below the container support portions of the pair of container support portions.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a dishwasher appliance according to an exemplary embodiment of the present subject matter.

FIG. 2 provides a section side view of the exemplary dishwasher appliance of FIG. 1.

FIG. 3 provides a perspective view of a wash rack according to an exemplary embodiment of the present subject matter and integrally formed elongated members of the wash rack.

FIG. 4 provides a perspective view of surfaces defined by the integrally formed elongated members of the exemplary wash rack of FIG. 3.

FIG. 5 provides a front, elevation view of the surfaces defined by the integrally formed elongated members of the exemplary wash rack of FIG. 3.

FIG. 6 provides a side, elevation view of the surfaces defined by the integrally formed elongated members of the exemplary wash rack of FIG. 3.

FIG. 7 provides atop, plan view of the surfaces defined by the integrally formed elongated members of the exemplary wash rack of FIG. 3.

FIG. 8 illustrates a method for forming a wash rack according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

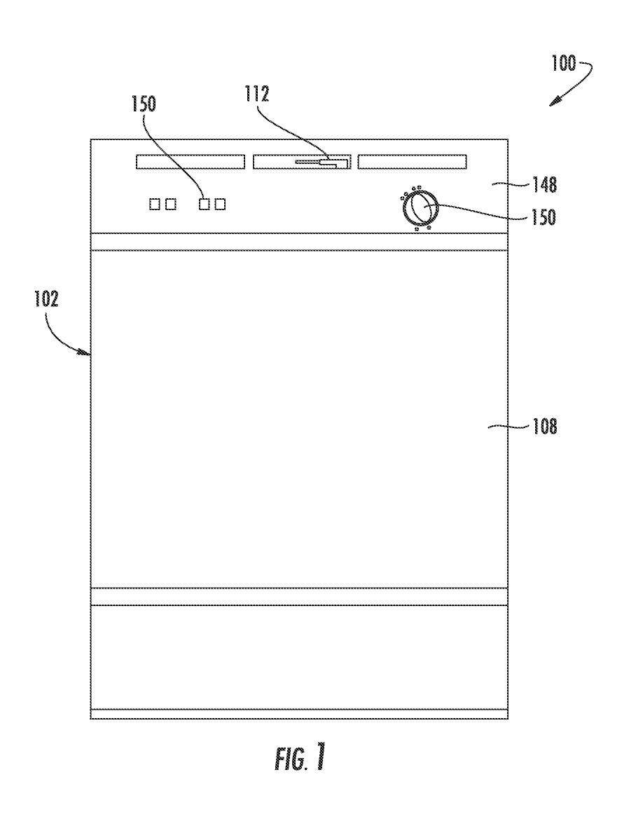

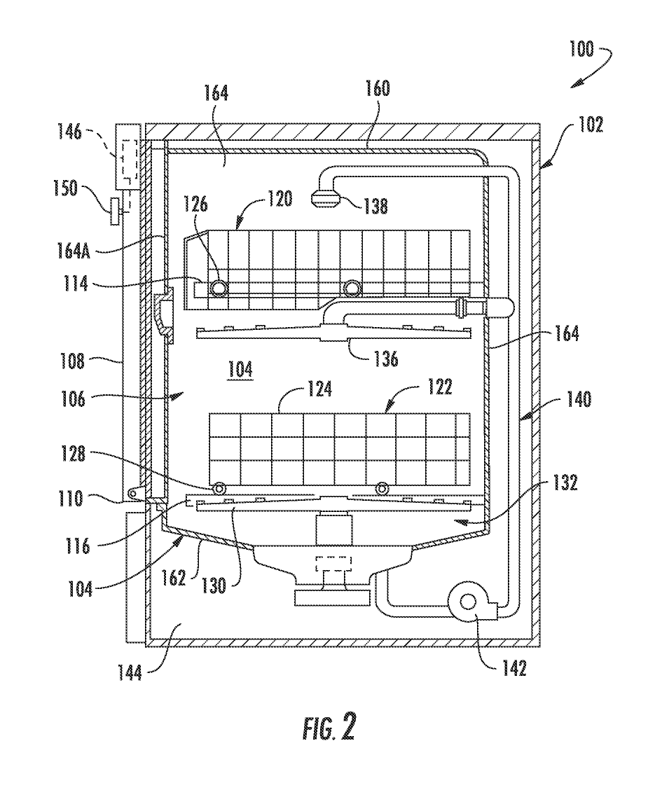

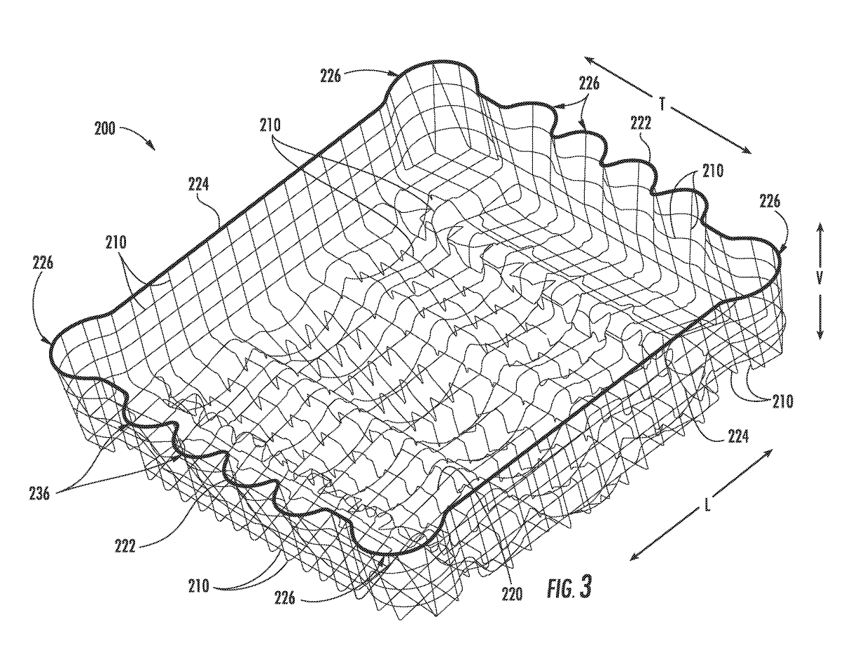

Referring now to the drawings, FIGS. 1-2 illustrate an exemplary embodiment of a dishwasher appliance 100 that may be configured in accordance with aspects of the present disclosure. As shown in the illustrated exemplary embodiment, dishwasher appliance 100 may include a cabinet 102 having a tub 104 therein defining a wash chamber 106. Tub 104 may generally include a front opening (not shown) and a door 108 hinged at its bottom 110 for movement between a normally closed vertical position (shown in FIGS. 1 and 2), wherein wash chamber 106 is sealed shut for washing operation, and a horizontal open position (shown in FIG. 3) for loading and unloading of articles from dishwasher appliance 100. As shown in FIG. 1, a latch 112 may be used to lock and unlock door 108 for access to wash chamber 106.

As is understood, tub 104 may generally have a rectangular cross-section defined by various wall panels or walls. For example, as shown in FIG. 2, tub 104 may include a top wall 160 and a bottom wall 162 spaced apart from one another along a vertical direction V of dishwasher appliance 100. Additionally, tub 104 may include a plurality of sidewalls 164 (e.g., four sidewalls) extending between the top and bottom walls 160 and 162. As shown in FIG. 3, a front sidewall 164A of tub 104 may generally define the inner wall or inner surface of door 108. It should be appreciated that tub 104 may generally be formed from any suitable material. However, in several embodiments, tub 104 may be formed from a ferritic material, such as stainless steel, or a polymeric material.

As particularly shown in FIG. 2, upper and lower guide rails 114, 116 may be mounted on opposing side walls 164 of tub 104 and may be configured to accommodate roller-equipped rack assemblies 120 and 122. Each of rack assemblies 120 and 122 may be fabricated into lattice structures including a plurality of elongated members 124 (for clarity of illustration, not all elongated members making up assemblies 120 and 122 are shown in FIG. 2). Additionally, each rack 120 and 122 may be adapted for movement between an extended loading position (not shown) in which the rack is substantially positioned outside wash chamber 106, and a refracted position (shown in FIGS. 1 and 2) in which rack is located inside wash chamber 106. This may be facilitated by rollers 126 and 128, for example, mounted onto racks 120 and 122, respectively. As is generally understood, a silverware basket (not shown) may be removably attached to rack assembly 122 for placement of silverware, utensils, and the like, that are otherwise too small to be accommodated by racks 120 and 122.

Additionally, dishwasher appliance 100 may also include a lower spray-arm assembly 130 that is configured to be rotatably mounted within a lower region 132 of wash chamber 106 directly above bottom wall 162 of tub 104 so as to rotate in relatively close proximity to rack assembly 122. As shown in FIG. 2, a mid-level spray-arm assembly 136 may be located in an upper region of wash chamber 106, such as by being located in close proximity to upper rack 120. Moreover, an upper spray assembly 138 may be located above upper rack 120.

As is generally understood, lower and mid-level spray-arm assemblies 130 and 136 and upper spray assembly 138 may generally form part of a fluid circulation system 140 for circulating fluid (e.g., water and dishwasher fluid) within the tub 104. As shown in FIG. 2, fluid circulation system 140 may also include a pump 142 located in a machinery compartment 144 below bottom wall 162 of tub 104, as is generally recognized in the art. Moreover, each spray-arm assembly 130 and 136 may include an arrangement of discharge ports or orifices for directing washing liquid onto dishes or other articles located in rack assemblies 120 and 122, which may provide a rotational force by virtue of washing fluid flowing through the discharge ports. The resultant rotation of lower spray-arm assembly 130 provides coverage of dishes and other dishwasher contents with a washing spray.

Dishwasher appliance 100 may be further equipped with a controller 146 configured to regulate operation of dishwasher appliance 100. Controller 146 may generally include one or more memory devices and one or more microprocessors, such as one or more general or special purpose microprocessors operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 146 may be positioned in a variety of locations throughout dishwasher appliance 100. In the illustrated embodiment, controller 146 is located within a control panel area 148 of door 108, as shown in FIG. 1. In such an embodiment, input/output (“I/O”) signals may be routed between the control system and various operational components of dishwasher appliance 100 along wiring harnesses that may be routed through bottom 110 of door 108. Typically, controller 146 includes a user interface panel/controls 150 through which a user may select various operational features and modes and monitor progress of dishwasher appliance 100. In one embodiment, user interface 150 may represent a general purpose I/O (“GPIO”) device or functional block. Additionally, user interface 150 may include input components, such as one or more of a variety of electrical, mechanical or electro-mechanical input devices including rotary dials, push buttons, and touch pads. User interface 150 may also include a display component, such as a digital or analog display device designed to provide operational feedback to a user. As is generally understood, user interface 150 may be in communication with controller 146 via one or more signal lines or shared communication busses.

It should be appreciated that the present subject matter is not limited to any particular style, model, or configuration of dishwasher appliance. The exemplary embodiment depicted in FIGS. 1 and 2 is simply provided for illustrative purposes only. For example, different locations may be provided for user interface 150, different configurations may be provided for racks 120 and 122, and other differences may be applied as well.

FIG. 3 provides a perspective view of a wash basket or rack 200 according to an exemplary embodiment of the present subject matter. Wash rack 200 may be used in or with any suitable dishwasher appliance. For example, wash rack 200 may be used in dishwasher appliance 100 (FIG. 2) as one of rack assemblies 120 and 122. Thus, wash rack 200 is described below in the context of dishwasher appliance 100. Wash rack 200 defines a vertical direction V, a lateral direction L and a transverse direction T that are mutually perpendicular and form an orthogonal direction system. As discussed in greater detail below, wash rack 200 includes features for improving performance of dishwasher appliance 100 and/or cleaning of articles within wash rack 200.

As may be seen in FIG. 3, wash rack 200 includes a plurality of integrally formed elongated members 210. Integrally formed elongated members 210 are connected or unitary with one another, e.g., such that integrally formed elongated members 210 are constructed of or with a continuous piece of material. For example, integrally formed elongated members 210 may be formed of or with a single, continuous thermoplastic, such as polybenzimidazole. As another example, integrally formed elongated members 210 may be formed for or with fibers or a blend of fibers encased within a matrix or shell of thermoplastic shell. Thus, integrally formed elongated members 210 may be constructed of or with a fiber-reinforced plastic, e.g., with a glass, carbon, basalt or aramid fiber encased within an epoxy, vinylester, polyester or nylon matrix or shell. As an example, each integrally formed elongated member 210 may be formed by extruding a fiber core and a thermoplastic shell together. As another example, each integrally formed elongated member 210 may be formed by extruding a fiber impregnated thermoplastic. Thus, the fibers may be disposed within a thermoplastic matrix within integrally formed elongated members 210.

Wash rack 200 includes a bottom wall 220, a pair of first side walls 222 and a pair of second side walls 224. In particular, integrally formed elongated members 210 form bottom wall 220, first side walls 222 and second side walls 224 of wash rack 200. Thus, bottom wall 220, first side walls 222 and second side walls 224 may be continuous or unitary with one another. As may be seen in FIG. 3, first side walls 222 are spaced apart from each other, e.g., along the lateral direction L, and extend upwardly, e.g., along the vertical direction V, from bottom wall 220. Similarly, second side walls 224 are spaced apart from each other, e.g., along the transverse direction T, and extend upwardly, e.g., along the vertical direction V, from bottom wall 220. First side walls 222 and second side walls 224 are joined together at corners 226 of wash rack 200.

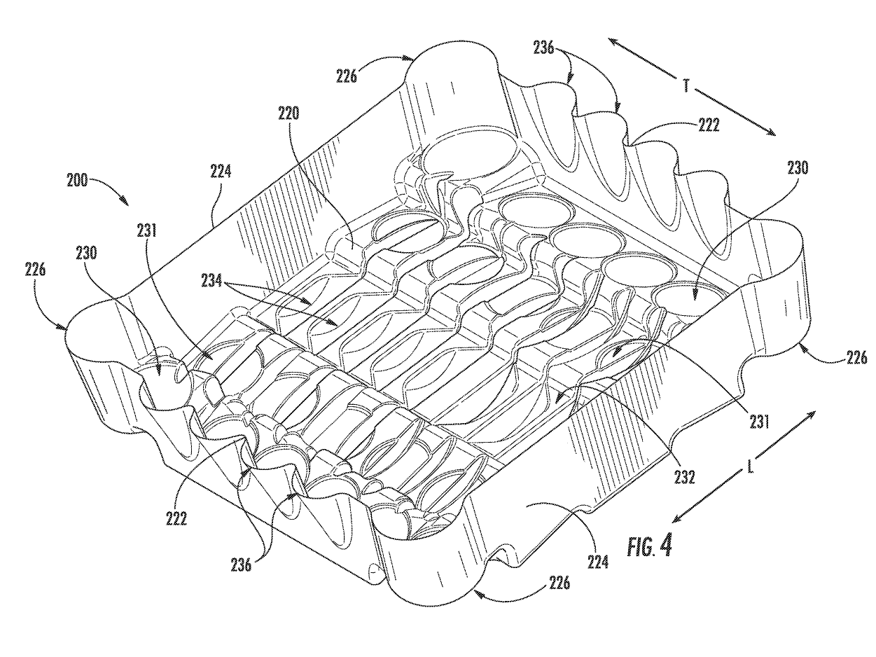

As may be seen in FIG. 3, integrally formed elongated members 210 collectively or jointly form wash rack 200, e.g., by forming bottom wall 220, first side walls 222 and second side walls 224 of wash rack 200. In addition, integrally formed elongated members 210 are complexly shaped along both the lateral direction L and the transverse direction T. In particular, none of integrally formed elongated members 210 may be entirely rectilinear along either the lateral direction L or the transverse direction T, in certain exemplary embodiments. For example, none of integrally formed elongated members 210 forming bottom wall 220 may be entirely rectilinear between first side walls 222 along the lateral direction L and/or between second sidewalls 224 along the transverse direction T. To assist with describing the shapes and contours provided by integrally formed elongated members 210 along the lateral direction L and the transverse direction T to form wash rack 200. Wash rack 200 is discussed in greater detail below in the context of FIGS. 4, 5, 6 and 7.

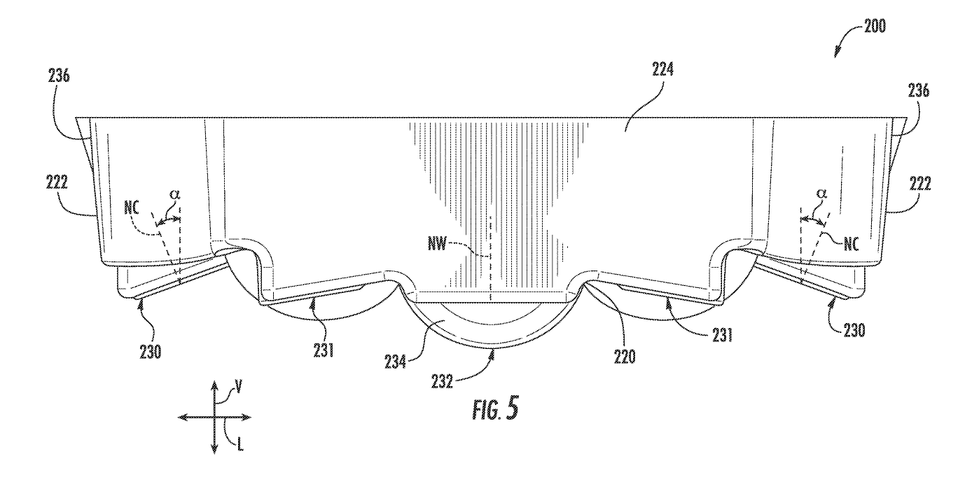

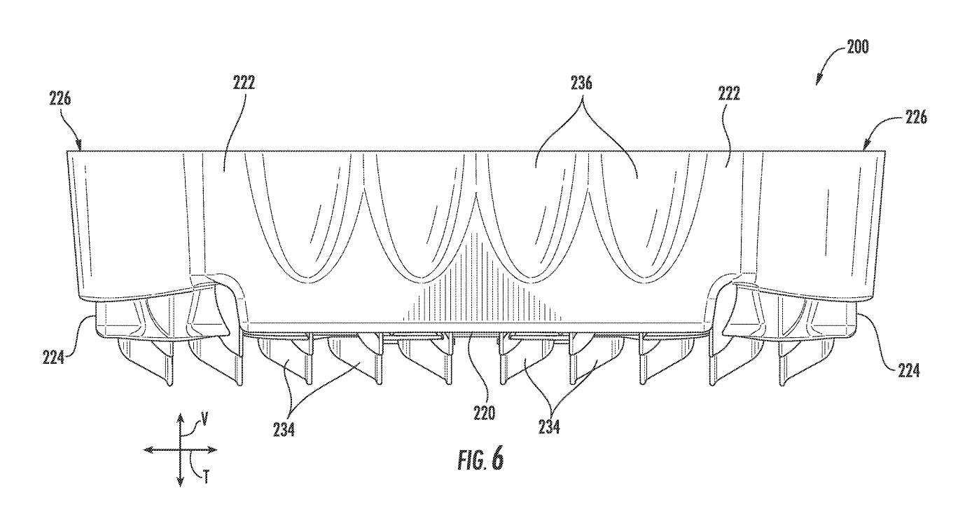

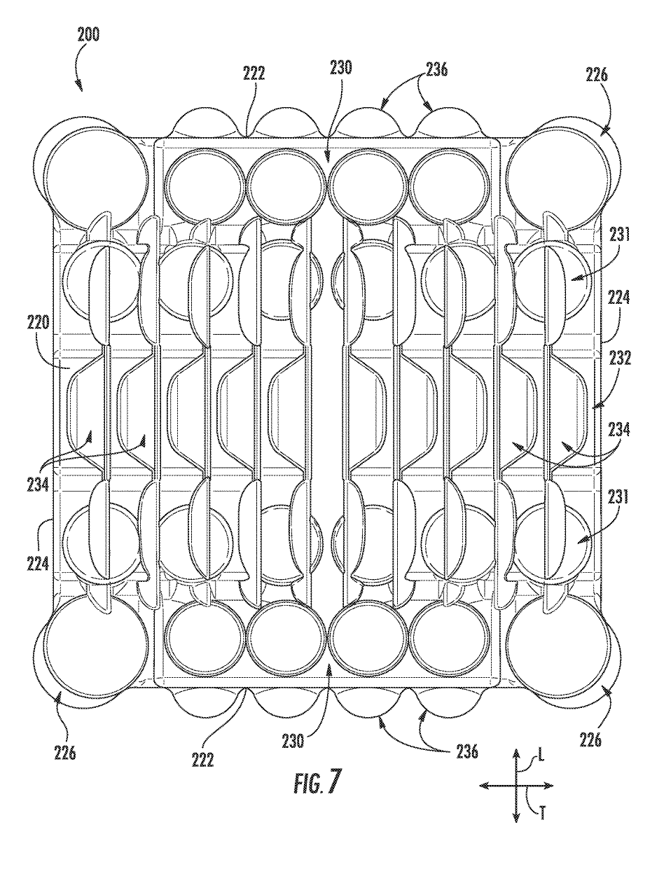

FIG. 4 provides a perspective view of surfaces defined by integrally formed elongated members 210 of wash rack 200. FIG. 5 provides a front, elevation view of the surfaces defined by integrally formed elongated members 210 of wash rack 200. FIG. 6 provides a side, elevation view of the surfaces defined by integrally formed elongated members 210 of wash rack 200. FIG. 7 provides atop, plan view of the surfaces defined by integrally formed elongated members 210 of wash rack 200. Thus, integrally formed elongated members 210 are not shown in FIGS. 4, 5, 6 and 7. Rather, surfaces formed by connecting the top and/or bottom portions of integrally formed elongated members 210 are shown in FIGS. 4, 5, 6 and 7 in order to show the shapes and/or contours provided by integrally formed elongated members 210 to support articles within wash rack 200.

Integrally formed elongated members 210 are formed to match the shape of the surfaces shown in FIGS. 4, 5, 6 and 7. As an example, FIG. 3 and FIG. 4 are the same view of wash rack 200. In FIG. 3, integrally formed elongated members 210 are shown, and integrally formed elongated members 210 are not shown in FIG. 4. Thus, it should be understood that wash rack 200 is not formed with solid surfaces as shown in FIGS. 4, 5, 6 and 7 but is rather formed with integrally formed elongated members 210 as shown in FIG. 3. However, for clarity and convenience, wash rack 200 is discussed in greater detail below in the context of FIGS. 4, 5, 6 and 7.

As may be seen in FIG. 4, bottom wall 220, e.g., integrally formed elongated members 210 of bottom wall 220, form a pair of container support portions 230 and a well portion 232. Each container support portion of container support portions 230 is positioned at or adjacent a respective one of first side walls 222. Thus, container support portions 230 are spaced apart from each other, e.g., along the lateral direction L, within wash rack 200 and may be positioned at opposite sides of wash rack 200, e.g., along the lateral direction L. Well portion 232 of bottom wall 220 is positioned between container support portions 230, e.g., along the lateral direction L. As, an example, well portion 232 of bottom wall 220 may be positioned at a middle portion of wash rack 200 and/or equidistant between container support portions 230, e.g., along the lateral direction L. Wash rack 200 may also include a pair of additional container support portions 231, e.g., positioned opposite each other about well portion 232 along the lateral direction L.

As may be seen in FIG. 5, well portion 232 of bottom wall 220 is also positioned below container support portions 230, e.g., along the vertical direction V. Thus, well portion 232 of bottom wall 220 may form or correspond to the lowest portion of wash rack 200, in certain exemplary embodiments. Well portion 232 of bottom wall 220 may be positioned below container support portions 230, e.g., along the vertical direction V, by any suitable distance or height. For example, well portion 232 of bottom wall 220 may be positioned below container support portions 230, e.g., along the vertical direction V, by no less than one inch and no more than five inches. As another example, well portion 232 of bottom wall 220 may be positioned below container support portions 230, e.g., along the vertical direction V, by no less than two inch and no more than four inches. Such positioning of well portion 232 of bottom wall 220 relative to container support portions 230 may assist with facilitating washing of articles on container support portions 230 and well portion 232, as discussed in greater detail below.

Container support portions 230 and well portion 232 of bottom wall 220 are configured for supporting articles for washing and angling or orienting the articles towards a spray body, such as mid-level spray-arm assembly 136 (FIG. 2), below wash rack 200. As an example, the spray body may be a spray arm rotatably mounted to wash rack 200 below well portion 232 of bottom wall 220. Thus, positioning well portion 232 of bottom wall 220 below container support portions 230 may assist with facilitating introduction of wash fluid from the spray body below wash rack 200 into articles on container support portions 230, e.g., by providing a greater vertical distance the spray body and articles on container support portions 230.

Container support portions 230 may also be angled or oriented towards the spray body below wash rack 200 in order to facilitate introduction of wash fluid from the spray body into articles on container support portions 230. In particular, container support portions 230 may be positioned and oriented such that openings of containers on container support portions 230 are directed towards or face the spray body below wash rack 200. As an example, a cup, glass or other suitable container may be positioned on container support portion 230 with an opening of the cup, glass or other suitable container positioned on the container support portion 230. In such a manner, wash fluid from the spray body below wash rack 200 may flow through bottom wall 220 into the cup, glass or other suitable container via the opening of the cup, glass or other suitable container in order to clean the article.

In certain exemplary embodiments, container support portion 230 may be angled or oriented such that normal lines (shown with arrows NC) from upper surfaces of container support portions 230 define an angle, a, with a normal line (shown with arrows NW) from an upper surface of well portion 232 of bottom wall 220. The angle α may be any suitable angle. For example, the angle α may be no less than about ten degrees and no greater than about thirty degrees. In particular, the angle α may be about twenty degrees. As used herein, the term “about” or “substantially” means within ten degrees of the stated angle when used in the context of angles. As may be seen in FIG. 5, the normal line NW from well portion 232 of bottom wall 220 may be substantially parallel to the vertical direction V. Thus, it should be understood that the angle α may also be defined between the normal lines NC from upper surfaces of container support portions 230 and the vertical direction V, in certain exemplary embodiments. The normal lines NC of container support portions 230 and/or the normal line NW from well portion 232 may also intersect or be directed towards the spray body below wash rack 200.

As may be seen in FIGS. 6 and 7, well portion 232 of bottom wall 220, e.g., integrally formed elongated members 210 of bottom wall 220 at well portion 232, forms or defines a plurality of bowl support cavities 234. Each bowl support cavity of bowl support cavities 234 is sized for receiving and support a bowl. Thus, integrally formed elongated members 210 at well portion 232 of bottom wall 220 may shaped to support bowls within bowl support cavities 234. Bowl support cavities 234 may have arcuately shaped integrally formed elongated members 210 (e.g., along the lateral direction L) and/or quadrant shaped integrally formed elongated members 210 (e.g., along the transverse direction T). Additional container support portions 231 may also be formed to support bowls and/or plates, as shown in FIGS. 6 and 7.

In addition, first side walls 222, e.g., integrally formed elongated members 210 at first side walls 222, form or define a plurality of container support cavities 236. Container support cavities 236 are sized for receiving a container supported on container support portions 230. For example, a sidewall of a container of container support portion 230 may be received within container support cavity 236 such that the sidewall of the cavity rests on first side wall 222 at container support cavity 236. Container support cavities 236 may have arcuately shaped integrally formed elongated members 210 (e.g., along the transverse direction T) and/or conically shaped integrally formed elongated members 210. Thus, first side walls 222 may be scalloped to from container support cavities 236.

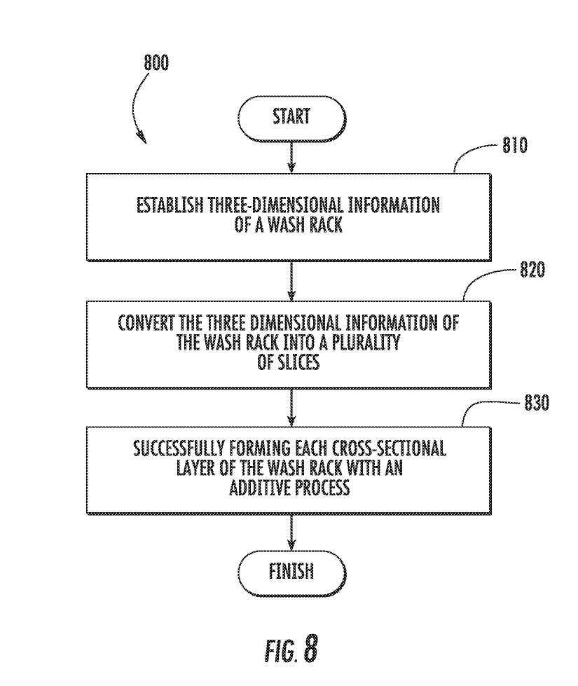

FIG. 8 illustrates a method 800 for forming a wash rack according to an exemplary embodiment of the present subject matter. Method 800 may be used to form any suitable wash rack. For example, method 800 may be used to form wash rack 200 (FIG. 3). Method 800 permits formation of various features of wash rack 200, as discussed in greater detail below. Method 800 includes fabricating wash rack 200 as a unitary wash rack, e.g., such that the various materials of wash rack 200 are integrally formed together. More particularly, method 800 includes manufacturing or forming wash rack 200 using an additive process, such as Stereolithography (SLA), Digital Light Processing (DLP), Laser Net Shape Manufacturing (LNSM) and other known processes. An additive process fabricates plastic components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 810, three-dimensional information of wash rack 200 is determined. As an example, a model or prototype of wash rack 200 may be scanned to determine the three-dimensional information of wash rack 200 at step 810. As another example, a model of wash rack 200 may be constructed using a suitable CAD program to determine the three-dimensional information of wash rack 200 at step 810. At step 820, the three-dimensional information is converted into a plurality of slices that each defines a cross-sectional layer of wash rack 200. As an example, the three-dimensional information from step 810 may be divided into equal sections or segments, e.g., along a central axis of wash rack 200 or any other suitable axis. Thus, the three-dimensional information from step 810 may be discretized at step 820, e.g., in order to provide planar cross-sectional layers of wash rack 200.

After step 820, wash rack 200 is fabricated using the additive process, or more specifically each layer is successively formed at step 830, e.g., by applying heat to melt and fuse a thermoplastic or polymerizing a resin using laser energy. The layers may have any suitable size. For example, each layer may have a size between about five ten-thousandths of an inch and about one thousandths of an inch. Wash rack 200 may be fabricated using any suitable additive manufacturing machine as step 830. For example, any suitable inkjet printer or laserjet printer may be used at step 830.

Utilizing method 800, wash rack 200 may have fewer components and/or joints than known wash racks. In addition, wash rack 200 may be formed with container support portions 230 and well portion 232 that assist with orienting articles within wash rack 200 towards a spray body below wash rack 200 and thereby facilitate cleaning of the articles with wash fluid form the spray body. Also, wash rack 200 may be less prone to breaks and/or be stronger when formed with method 800. Further, wash rack 200 may be constructed without metal wires that are susceptible to corrosion or rusting.

In addition, utilizing method 800 may assist with forming bottom wall 220 such that bottom wall 220 is tiered or stepped, e.g., along the vertical direction V, after step 830. Thus, the lowest point of bottom wall 220 may correspond to a central portion of bottom wall 220, e.g., along the lateral direction V, and other portions of bottom wall 220 may be successively raised or elevated to provide additional space along the vertical direction V, after step 830. Further, utilizing method 800, bottom wall 220 may be angled or oriented to such that containers on bottom wall 220 are angled or oriented towards the spray body below wash rack 200 after step 830.

Such shaping of bottom wall 220 may assist with facilitating washing of articles on bottom wall 220. For example, the spray body may be a spray arm that rotates around an axis of rotation below bottom wall 220. Thus, the spray body may rotate in a generally circular pattern, e.g., in a plane that is perpendicular to the vertical direction V, below bottom wall 220 during operation of dishwasher appliance 100. Conversely, wash rack 200 may have a generally square shape, e.g., in a plane that is perpendicular to the vertical direction V. To conserve space along the vertical direction V below wash rack 200, the spray body may be positioned close, e.g., as close as possible, to bottom wall 220 along the vertical direction V. Due to the shape of wash rack 200 relative to the rotation pattern of the spray body and the close proximity of the spray body to wash rack 200, directing wash fluid from the spray body towards corners 226 of wash rack 200 and into articles at corners 226 of wash rack 200 can be difficult, particularly tall glasses or container positioned at corners 226 of wash rack 200. Angling jets of wash fluid from the spray body towards the corners 226 of wash rack 200 offers limited effectiveness due angling required to reach corners 226 of wash rack 200 and potential blocking of the wash fluid jets by other articles in the wash rack 200.

Positioning container support portions 230 above well portion 232 and/or angling or orienting container support portions 230 towards the spray body below wash rack 200 may assist with directing wash fluid from the spray body rotating below wash rack 200 into the articles supported on bottom wall 220 of wash rack 200. Thus, method 800 may assist with forming wash rack 200 such that a height of outer portions of bottom wall 220 along the vertical direction V relative to the spray body below wash rack 200 is traded (e.g., increased) in order to facilitate impingement of wash fluid from the spray body onto the articles at the outer portions of bottom wall 220. In particular, the height of outer portions of bottom wall 220 along the vertical direction V relative to the spray body below wash rack 200 may be selected depending on radial distance from the axis of rotation of the spray body below wash rack 200. For example, the height of outer portions of bottom wall 220 along the vertical direction V relative to the spray body below wash rack 200 may be greatest at the portions of bottom wall 220 positioned at a greatest radial distance from the axis of rotation of the spray body below wash rack 200, e.g., at corners 226 of wash rack 200. In such manner, wash fluid application from the spray body below wash rack 200 may be improved at corners 226 of wash rack 200.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance defining a vertical direction, a lateral direction and a transverse direction that are mutually perpendicular, the dishwasher comprising:
a tub defining a wash chamber;
a spray body positioned within the wash chamber of the tub; and
a wash rack positioned within the wash chamber of the tub above the spray body along the vertical direction, the wash rack comprising a plurality of integrally formed elongated members, the integrally formed elongated members of the wash rack forming a bottom wall, a pair of first side walls and a pair of second side walls, the side walls of the pair of first side walls spaced apart from each other along the lateral direction and extending upwardly from the bottom wall of the wash rack along the vertical direction, the side walls of the pair of second side walls spaced apart from each other along the transverse direction and extending upwardly from the bottom wall of the wash rack along the vertical direction,
wherein the integrally formed elongated members of the bottom wall form a pair of container support portions and a well portion, each container support portion of the pair of container support portions positioned adjacent a respective one of the pair of first side walls, the well portion of the bottom wall positioned between the container support portions of the pair of container support portions along the lateral direction, the well portion of the bottom wall also positioned below the container support portions of the pair of container support portions along the vertical direction.

2. The dishwasher appliance of claim 1, wherein the integrally formed elongated members of the wash rack are formed of a single, continuous fiber reinforced thermoplastic.

3. The dishwasher appliance of claim 1, wherein the integrally formed elongated members of the wash rack are formed of a single, continuous thermoplastic.

4. The dishwasher appliance of claim 1, wherein the container support portions of the pair of container support portions are angled towards the spray body.

5. The dishwasher appliance of claim 4, wherein normal lines from upper surfaces of the container support portions of the pair of container support portions define an angle, α, with a normal line from an upper surface of the well portion of the bottom wall, the angle α being no less than about ten degrees and no greater than about thirty degrees.

6. The dishwasher appliance of claim 5, wherein the normal line from the upper surface of the well portion of the bottom wall is substantially parallel to the vertical direction.

7. The dishwasher appliance of claim 1, wherein the integrally formed elongated members of the bottom wall at the well portion of the bottom wall define a plurality of bowl support cavities, each bowl support cavity of the plurality of bowl support cavities sized for receiving a bowl.

8. The dishwasher appliance of claim 1, wherein the integrally formed elongated members of the side walls of the pair of first side walls define a plurality of container support cavities, each container support cavity of the container support cavities sized for receiving a container supported on the container support portions of the pair of container support portions.

9. The dishwasher appliance of claim 1, wherein the container support portions of the pair of container support portions are positioned and oriented such that openings of containers on the container support portions of the pair of container support portions are directed towards the spray body.

10. The dishwasher appliance of claim 1, wherein the integrally formed elongated members of the bottom wall are not rectilinear between the side walls of the pair of second side walls.

11. A method for forming a unitary wash rack for a dishwasher appliance, comprising:
establishing three-dimensional information of the unitary wash rack;
converting the three-dimensional information of the unitary wash rack from said step of establishing into a plurality of slices, each slice of the plurality of slices defining a respective cross-sectional layer of the unitary wash rack; and
successively forming each cross-sectional layer of the unitary wash rack with an additive process,
wherein, after said step of successively forming: (1) the unitary wash rack includes a plurality of integrally formed elongated members forming a bottom wall and a pair of side walls; (2) the side walls of the pair of side walls are spaced apart from each other and extend upwardly from the bottom wall; (3) the integrally formed elongated members of the bottom wall form a pair of container support portions and a well portion; (4) each container support portion of the pair of container support portions is positioned adjacent a respective one of the pair of side walls; (5) the well portion of the bottom wall is positioned between the container support portions of the pair of container support portions; and (6) the well portion of the bottom wall is also positioned below the container support portions of the pair of container support portions.

12. The method of claim 11, wherein the additive process comprises at least one of fused deposition modeling, selective laser sintering, stereolithography and digital light processing.

13. The method of claim 11, wherein the unitary spray arm is a continuous piece of material after said step of successively forming, the continuous piece of material comprising a thermoplastic or a fiber reinforced thermoplastic.

14. The method of claim 11, wherein the container support portions of the pair of container support portions are angled towards the spray body. after said step of successively forming

15. The method of claim 14, wherein normal lines from upper surfaces of the container support portions of the pair of container support portions define an angle, α, with a normal line from an upper surface of the well portion of the bottom wall after said step of successively forming, the angle α being no less than about ten degrees and no greater than about thirty degrees.

16. The method of claim 15, wherein the normal line from the upper surface of the well portion of the bottom wall is substantially parallel to the vertical direction.

17. The method of claim 11, wherein the integrally formed elongated members of the bottom wall at the well portion of the bottom wall define a plurality of bowl support cavities after said step of successively forming, each bowl support cavity of the plurality of bowl support cavities sized for receiving a bowl.

18. The method of claim 11, wherein the integrally formed elongated members of the side walls of the pair of first side walls define a plurality of container support cavities after said step of successively forming, each container support cavity of the container support cavities sized for receiving a container supported on the container support portions of the pair of container support portions.

19. The method of claim 11, wherein the container support portions of the pair of container support portions are positioned and oriented such that openings of containers on the container support portions of the pair of container support portions are directed towards the spray body after said step of successively forming.

20. The method of claim 11, wherein the integrally formed elongated members of the bottom wall are not rectilinear between the side walls of the pair of second side walls after said step of successively forming.
